(19) United States
(12) Patent Application Publication
(10) Pub. No.: US 2007/0288776 A1
(43) Pub. Date: Dec. 13, 2007

(54) METHOD AND APPARATUS FOR POWER MANAGEMENT IN A DATA PROCESSING SYSTEM

(76) Inventors: Jonathan James DeMent, Austin, TX (US); Clark McKerall O'Niell, White Plains, NY (US); Steven Leonard Roberts, Cedar Park, TX (US)

Correspondence Address: IBM CORP (YA);C/O YEE & ASSOCIATES PC, P.O. BOX 802333, DALLAS, TX, 75380, US

(21) Appl. No.: 11/423,291

(22) Filed: Jun. 9, 2006

(51) Int. Cl. G06F 1/32

(52) U.S. Cl. 713/320

(57) ABSTRACT

A computer implemented method, apparatus, and computer usable program code for managing power consumption in a cache. A set of sections is identified in the cache used by the process in response to identifying a process requesting access to a cache. Power is enabled to each section in the set of sections in which power is disabled. The power is disabled to sections outside of the set of sections in which power is enabled.

### BACKGROUND

1. Field of the Invention

The present application relates generally to improved data processing system and in particular to a method and apparatus for managing data in a data processing system. Still more particularly, the present invention relates to a computer implemented method, apparatus, and computer usable program code for managing data in a manner that allows for reducing power usage in a data processing system memory or cache.

2. Description of the Related Art

Power management in data processing systems is important for a number of different reasons. For example, power management is important with mobile data processing systems, such as laptops, because reduced power usage results in improved battery performance to allow for longer usage of a mobile data processing system. Power management also is important in other types of data processing systems. For example, with servers in a data center, the reduction of power usage is important to reduce the generation of heat. In a given data processing system, such as a server, the generation of heat may cause the operation of components within the server to fail or operate incorrectly. This thermal issue is further exasperated when a large number of servers are present in a small location. Further, the consumption of power also provides a challenge in running servers in a cost effective manner. For example, the power consumption in a data center containing many servers gives rise to a cost concern based on the power consumption.

Different power management schemes have been implemented to deal with these power issues. For example, current power management schemes may turn off or disable components, such as, for example, displays, hard disk drives, and network adapters when those devices are not in use. Cooling systems also are used in data processing systems and in facilities, such as data management centers. These types of solutions, however, do not address the cost issues associated with power consumption by the servers and the additional power consumption caused by the use of cooling systems. Other mechanisms used to reduce power consumption include reducing the speed at which processors operate, depending upon the demands on those processors. By reducing the speed at which a processor executes, power consumption and heat generation may be reduced, addressing both thermal and cost issues. Additional power management schemes in addition to those currently available are desirable.

### SUMMARY OF THE INVENTION

The present invention provides a computer implemented method, apparatus, and computer usable program code for managing power consumption in a cache. A set of sections is identified in the cache used by the process in response to identifying a process requesting access to a cache. Power is enabled to each section in the set of sections in which power is disabled. The power is disabled to sections outside of the set of sections in which power is enabled.

### BRIEF DESCRIPTION OF THE DRAWINGS

The novel features believed characteristic of the illustrative embodiments are set forth in the appended claims. The illustrative embodiments themselves, however, as well as a preferred mode of use, further objectives and advantages thereof, will best be understood by reference to the following detailed description of the illustrative embodiments when read in conjunction with the accompanying drawings, wherein:

FIG. 1 is a block diagram of a data processing system in which aspects of the present invention may be implemented;

FIG. 2 is an exemplary diagram of a cell broadband engine chip in which aspects of the illustrative embodiments may be implemented in accordance with an illustrative embodiment;

FIG. 3 is a diagram of a memory flow controller in accordance with an illustrative embodiment;

FIG. 4 is a diagram illustrating components used to write data into different portions of a cache, and to control the use of power by those different portions of the cache, in accordance with an illustrative embodiment;

FIG. 5 is a diagram illustrating components in a cache that may be selectively enabled and disabled in accordance with an illustrative embodiment;

FIG. 6 is a diagram illustrating an effective address based on a replacement management table in accordance with an illustrative embodiment;

FIG. 7 is a diagram illustrating fields in an entry for a replacement management table in accordance with an illustrative embodiment;

FIG. 8 is a flowchart of a process for writing data into a cache in accordance with an illustrative embodiment; and

FIG. 9 is a flowchart of a process for managing power to a cache in accordance with an illustrative embodiment.

### DETAILED DESCRIPTION OF THE PREFERRED EMBODIMENT

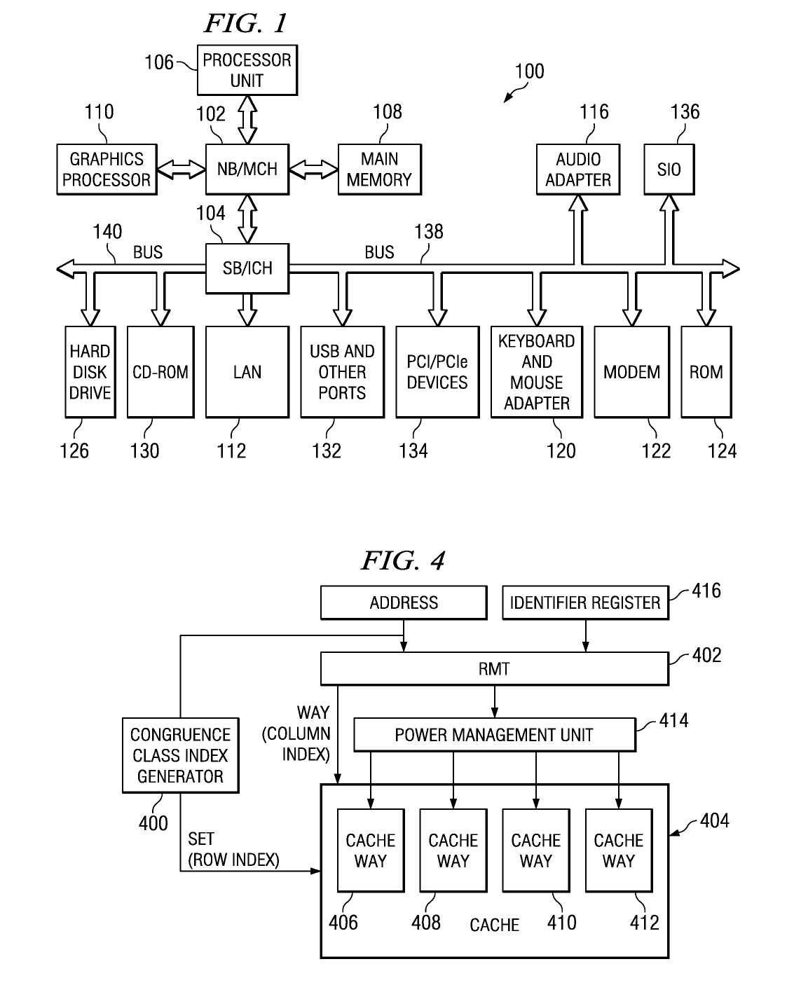

With reference now to the figures and in particular with reference to FIG. 1, a block diagram of a data processing system is shown in which aspects of the present invention may be implemented. Data processing system 100 is an example of a computer in which code and/or apparatus implementing the aspects of the present invention may be located. In the depicted example, data processing system 100 employs a hub architecture including a north bridge and memory controller hub (MCH) 102 and a south bridge and input/output (I/O) controller hub (ICH) 104. Processor unit 106, main memory 108, and graphics processor 110 are connected to north bridge and memory controller hub 102. Processor unit 106 contains a set of one or more processors. When more than one processor is present, these processors may be separate processors in separate packages. Alternatively, the processors may be multiple cores in a package. Further, the processors may be multiple multi-core units. Graphics processor 110 may be connected to the MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor unit 106 and coordinates and provides control of various components within data processing system 100 in FIG. 1. The operating system may be a commercially available operating system such as Linux. An object oriented programming system, such as the Java™ programming system, may run in conjunction with the operating system and provides calls to the operating system from Java programs or applications executing on data processing system 100 (Java is a trademark of Sun Microsystems, Inc. in the United States, other countries, or both).

Instructions for the operating system, the object-oriented programming system, and applications or programs are located on storage devices, such as hard disk drive 126, and may be loaded into main memory 108 for execution by processor unit 106. The processes of the present invention are performed by processor unit 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the present invention may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted examples in FIG. 1 and above-described examples are not meant to imply architectural limitations.

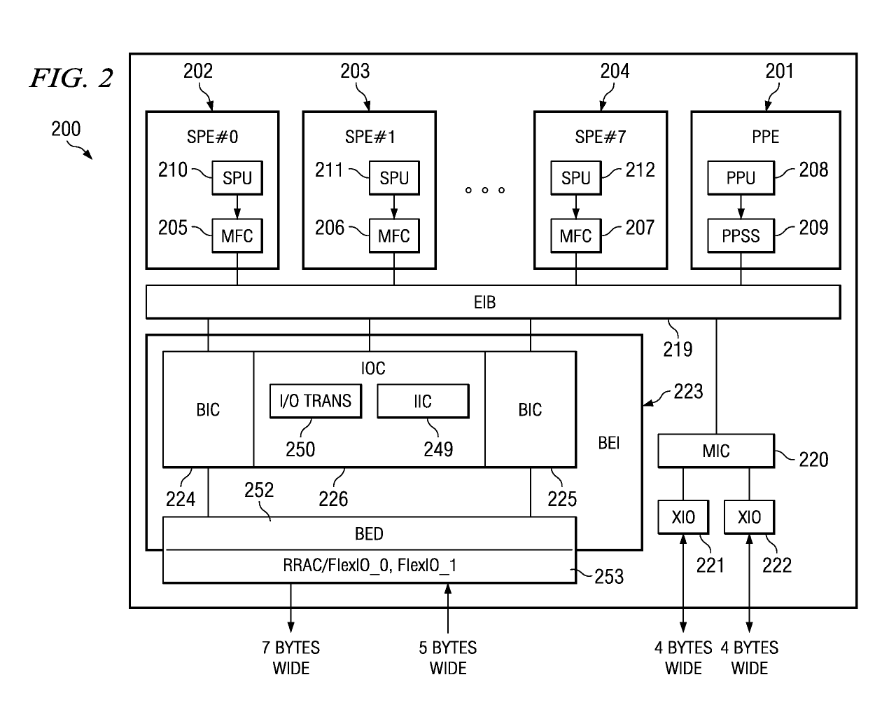

FIG. 2 is an exemplary diagram of a cell broadband engine chip in which aspects of the illustrative embodiments may be implemented in accordance with an illustrative embodiment. Cell broadband engine chip 200 is a single-chip multiprocessor implementation directed toward distributed processing targeted for media-rich applications such as game consoles, desktop systems, and servers.

Cell broadband engine chip 200 may be logically separated into the following functional components: Power PC® processor element (PPE) 201, synergistic processor units (SPU) 210, 211, and 212, and memory flow controllers (MFC) 205, 206, and 207. Although synergistic processor elements and Power PC® processor elements are shown by example, any type of processor element may be supported. In these examples, cell broadband engine chip 200 implementation includes one Power PC® processor element 201 and eight synergistic processor elements, although FIG. 2 shows only three synergistic processor elements (SPEs) 202, 203, and 204. The synergistic processor element (SPE) of a CELL Processor is a first implementation of a new processor architecture designed to accelerate media and data streaming workloads.

Each synergistic processor element includes one synergistic processor unit (SPU) 210, 211, or 212 with its own local store (LS) area and a dedicated memory flow controller (MFC) 205, 206, or 207 that has an associated memory management unit (MMU) to hold and process memory protection and access permission information. Once again, although synergistic processor units are shown by example, any type of processor unit may be supported. Additionally, cell broadband engine chip 200 implements element interconnect bus (EIB) 219 and other I/O structures to facilitate on-chip and external data flow.

Element interconnect bus 219 serves as the primary on-chip bus for Power PC® processor element 201 and synergistic processor elements 202, 203, and 204. In addition, element interconnect bus 219 interfaces to other on-chip interface controllers that are dedicated to off-chip accesses. The on-chip interface controllers include the memory interface controller (MIC) 220, which provides two extreme data rate I/O (XIO) memory channels 221 and 222, and cell broadband engine interface unit (BEI) 223, which provides two high-speed external I/O channels and the internal interrupt control for the cell broadband engine 200. The cell broadband engine interface unit 223 is implemented as bus interface controllers (BIC & BIC) 224 and 225 and I/O interface controller (IOC) 226. The two high-speed external I/O channels connected to a polarity of RRAC interfaces providing the flexible input and output (FlexIO_{—}0 & FlexIO_{—}1) 253 for the cell broadband engine 200.

Main storage is shared by Power PC® processor unit 208, the power processor element (PPE) 201, synergistic processor elements (SPEs) 202, 203, and 204, and I/O devices in a system. All information held in this level of storage is visible to all processors and devices in the system. Programs reference this level of storage using an effective address. Since the memory flow controller synergistic processor unit command queue and the memory flow controller proxy command queue and control and status facilities are mapped to the effective address space, it is possible for power processor element 201 to initiate direct memory access operations involving a local store area associated with any of synergistic processor elements (SPEs) 202, 203, and 204.

A synergistic processor unit program accesses main storage by generating and placing a direct memory access data transfer command, with the appropriate effective address and local store address, into its memory flow controllers (MFCs) 205, 206, or 207 command queue for execution. When executed, the required data are transferred between its own local store area and main storage. Memory flow controllers (MFCs) 205, 206, or 207 provide a second proxy command queue for commands generated by other devices such as the power processor element (PPE) 201. The proxy command queue is typically used to store a program in local storage prior to starting the synergic processor unit. Proxy commands can also be used for context store operations.

The effective address part of the data transfer is much more general, and can reference main storage, including all synergistic processor unit local store areas. These local store areas are mapped into the effective address space. The data transfers are protected. An effective address is translated to a real address through a memory management unit. The translation process allows for virtualization of system memory and memory protection.

Power PC® processor element 201 on cell broadband engine chip 200 consists of 64-bit Power PC® processor unit 208 and Power PC® storage subsystem 209. Synergistic processor units (SPUs) 210, 211, or 212 and memory flow controllers 205, 206, and 207 communicate with each other through unidirectional channels that have capacity. The channel interface transports messages to and from memory flow controllers 205, 206, and 207, synergistic processor units 210, 211, and 212.

Element interconnect bus 219 provides a communication path between all of the processors on cell broadband engine chip 200 and the external interface controllers attached to element interconnect bus 219. Memory interface controller 220 provides an interface between element interconnect bus 219 and one or two of extreme data rate I/O cell memory channels 221 and 222. Extreme data rate (XDR™) dynamic random access memory (DRAM) is a high-speed, highly serial memory provided by Rambus. The extreme data rate dynamic random access memory is accessed using a macro provided by Rambus, referred to in this document as extreme data rate I/O cell memory channels 221 and 222.

Memory interface controller 220 is only a slave on element interconnect bus 219. Memory interface controller 220 acknowledges commands in its configured address range(s), corresponding to the memory in the supported hubs.

Bus interface controllers (BICs) 224 and 225 manage data transfer on and off the chip from element interconnect bus 219 to either of two external devices. Bus interface controllers 224 and 225 may exchange non-coherent traffic with an I/O device, or it can extend element interconnect bus 219 to another device, which could even be another cell broadband engine chip. When used to extend the element interconnect bus, coherency is maintained between caches in the cell broadband engine and caches in the external device attached.

I/O interface controller 226 handles commands that originate in an I/O interface device and that are destined for the coherent element interconnect bus 219. An I/O interface device may be any device that attaches to an I/O interface such as an I/O bridge chip that attaches multiple I/O devices or another cell broadband engine chip 200 that is accessed in a non-coherent manner. I/O interface controller 226 also intercepts accesses on element interconnect bus 219 that are destined to memory-mapped registers that reside in or behind an I/O bridge chip or non-coherent cell broadband engine chip 200, and routes them to the proper I/O interface. I/O interface controller 226 also includes internal interrupt controller (IIC) 249 and I/O address translation unit (I/O Trans) 250.

The illustrative embodiments provide a computer implemented method, apparatus, and computer usable program code for managing power in a data processing system. The illustrative embodiments recognize that power consumption by memory may account for a significant portion of power dissipation on a chip. In one example, a processor cache accounts for twenty-seven percent (27%) of the power dissipation on an entire chip. Thus, the illustrative embodiments recognize that controlling power usage in these areas are paramount to controlling overall power dissipation.

As a result, the aspects illustrative embodiments implement a mechanism to save power based on how an application uses memory. Currently, selectively enabling or disabling portions of a cache are not practical because data used by different applications may be found throughout the different sections. The illustrative embodiments provide a mechanism to assign an identifier, such as a class identifier, to memory addresses used by code, such as an application or thread. Applications are typically confined to a range of memory. The use of a class identifier may be used to represent a particular application or thread of execution. A thread of execution is a process or sub-application for an application. The class identifier is used at the time the multi-way, set-associative cache is accessed for a read or write operation to limit the ways of the cache in which the data can reside. The different aspects are not applicable to a direct mapped or fully-associative cache in these illustrative examples.

In an illustrative embodiment and in the following examples, a way or cache way is a portion of the cache that may be enabled or disabled. A power management unit may be implemented in the cache to prevent powering up or removal of power from different cache ways or sections of the cache in which data is not known to reside.

Portions of the cache that are unused by a currently executing process may be disabled such that power is not applied to those portions of the cache. Portions of the cache containing data for a process that is currently executing are not disabled so that those portions of the cache are powered. In this manner, portions of the cache may be power enabled and power disabled to reduce the overall power usage. Furthermore, when multiple cache ways are powered, the power to the read and write logic of these cache ways can be selectively enabled and disabled when not required for the accessing process.

This particular mechanism supports a more granular approach as to how memory management is formed for a cache. Instead of completely turning on or off the entire cache, the illustrative embodiments may enable or disable portions of the cache and the cache-accessing logic may be enabled and disabled to provide an ability to reduce power usage. In these illustrative examples, the different embodiments are implemented within a memory flow controller within a processor. Of course, illustrative embodiments may be implemented within any sort of control circuitry or program usable code for controlling memory usage in a cache. Additionally, illustrative embodiments also may be applied to other types of memory other than caches depending on the particular implementation (in general, any memory that is multi-way set associative).

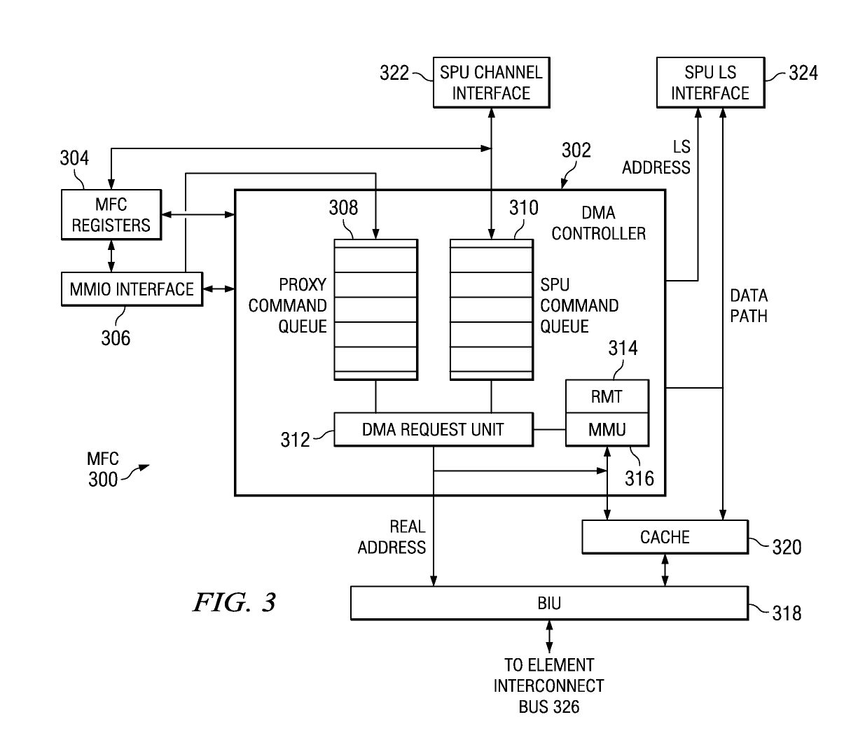

Turning now to FIG. 3, a diagram of a memory flow controller is depicted in accordance with an illustrative embodiment. In this example, memory flow controller 300 is an example of a memory flow controllers (MFCs) 205-207 in FIG. 2.

As illustrated, memory flow controller 300 contains direct memory access (DMA) controller 302, memory flow controller (MFC) registers 304, and memory mapped input/output (MMIO) interface 306. DMA controller 302 contains proxy command queue 308, synergistic processor command queue 310, DMA request unit 312, replacement management table (RMT) 314, and memory management unit (MMU) 316.

Memory flow control registers 304 provide an area for information to be stored within memory flow controller 300. The information in these registers are received from different entities interfacing with memory flow controller 300. For example, these entities include a process running on a synergistic processing unit or a process running on another processor.

SPU channel interface 322 and SPU LS interface 324 are interfaces to a synergistic processor unit. A synergistic processor unit uses these interfaces to control memory flow controller 300. A synergistic processor unit sends commands to memory flow controller 300 through SPU channel interface 322. A synergistic processor unit sends data to memory flow controller 300 through SPU LS interface 324. Bus interface unit (BIU) 318 provides an interface between memory flow controller 300 and other processors and devices. Memory flow controller 300 communicates with a synergistic processor unit through SPU channel interface 322 and SPU local store (LS) interface 324. Additionally, memory flow controller 300 contains connections to bus interface unit (BIU) 318. Some components in memory flow controller 300 connect directly to bus interface unit 318, while other components connect to bus interface unit 318 through cache 320. A cache line lookup into cache 320 has two parts. The first part involves generating an index to a row within the cache. A congruence class is a row of data, while a set is a column of data. Then, the ways in the congruence class are activated and the congruence class is searched across all ways for the desired data. Bus interface unit 318 connects to an element interconnect bus 326.

MMIO interface 306 maps registers within memory flow control registers 304 into a real address space. A real address space is the address space in a main storage, such as system memory. DMA controller 302 copies a block or section of memory from one device to another. In these examples, the devices may be different processor cores, such as a synergistic processor unit. DMA controller 302 manages these types of data transfers. Proxy command queue 308 is a queue that holds commands received from processors and devices other than the synergistic processing unit associated with DMA controller 302. SPU command queue 310 holds commands received from the associated synergistic processor unit. In these examples, the different commands are received through SPU channel interface 322. The different data transfer commands may involve both a local storage address (LSA) and effective address (EA). A local storage address can directly address only local storage associated with the synergistic processor unit. A device, such as a processor, uses an effective address to reference main storage, such as system memory. This main storage also may include, for example, local storage areas within a synergistic processor unit.

DMA request unit 312 processes commands in proxy command queue 308 and SPU command queue 310. DMA request unit 312 generates requests in response to the different commands in these queues. Memory management unit 316 processes an effective address found in a command received from DMA request unit 312. Memory managed unit 316 converts the effective address (EA) into a real address (RA). An effective address is the address of an operand that is stored in a register or memory in place of the operand itself. The real address is an address of a fixed location in memory.

In these examples, replacement management table 314 controls cache replacement in a cache, such as cache 320. Further, replacement management table 314 contains information identifying where in cache 320 data should be placed (i.e. which way of cache 320 contains the data). For example, when a process, such as one being executed by a synergistic processor unit, generates a command to write data into cache 320, the synergistic processor stores the command in SPU command queue 310. Replacement management table 314 controls the particular location (i.e. the cache way) in which memory management unit 316 writes this information into cache 320.

In the illustrative examples, replacement management table 314 is modified from the normal use to include an identification of the application for which a piece of data is associated. Memory management unit 316 uses this identifier to write or place the data into cache 320 in a particular location (i.e. the cache way).

The illustrative embodiments select this location as one in which power is enabled to that particular way of the cache. In this example, the identifier is for a process determined on an application basis. These identifiers may be assigned on other scales, such as on a per process thread basis, based on the address associated with the process or application. The identification is addressed based on these illustrative examples. Also, the data path remains untouched. As used herein, a process may be any unit of code executed, such as an application or a thread. As a result, whenever a processor is executing within the memory range of the class identifier, cache 320 may be disabled for unused ways or sections for the particular class identifier. Alternatively, the read/write logic may be disabled instead of the way.

Turning now to FIG. 4, a diagram illustrating components used to write data into different portions of a cache and control the use of power by those different portions of cache is depicted in accordance with an illustrative embodiment. In this example, congruence class index generator (CCIG) 400 uses replacement management table (RMT) 402 to control the manner in which data is written into cache 404. In this example, replacement management table 402 contains identifications of sets, replacement policies, bypass indicators, and validity indicators. These entries are used to identify data within cache 404 for replacement or retention, as well as performing power management functions on cache 404 as described in more detail below.

In this example, cache 404 contains four sections (a 4-way, set-associative cache), which are also referred to as cache ways. Cache ways 406, 408, 410, and 412 hold data for a processor, such as a synergistic processing unit. Congruence class index generator 400 writes the data into different cache ways using replacement management table 402. In these examples, data and/or instructions for different processes are associated with identifiers in replacement management table 402.

Additionally, the illustrative embodiments may enable or disable power to the different cache ways using power management unit 414. A cache way or section of a cache within cache 404 is considered enabled when power is supplied by power management unit 414 to that portion of the cache. Power is considered disabled when power is turned off to that particular cache way. This can be accomplished by various common means in the art, such as placing a pass gate transistor in the power lines feeding the cache that is activated or deactivated by the power management unit 414 to enable or disable power to the cache respectively.

Congruence class index generator 400 and RMT 402 work together to select the congruence class and way to write data into different portions of cache 404 based on a class identifier or other identifier associated with an application or process being executed by a processor. The identifier for the application is used to locate one or more cache ways in which the data may be written.

This identifier is located in identifier register 416 in these examples. Different mechanisms may write the information into this register. For example, the operating system may place the identification of the active application in this register as a normal part of switching between applications. The switching of applications is referred to as a context switch in which data for a process going into an inactive or background state is stored and data for an application becoming active is restored for use by a processor. In a context switch, the storing and restoring of data is with respect to the state of a processor. This location information is found in replacement management table 402.

Through software management, replacement management table 402 uses the identifier obtained from identifier register 416 along with the application or process memory address to find the particular cache way in which the data is to be written. Although the different examples are described with respect to an application, the identification of locations for data may be made for different processes other than an application. For example, the different illustrative embodiments may be applied to processes taking the form of a thread.

In one illustrative example, a streaming type application, such as one for rendering DVD content places data into cache 404. In these examples, power management unit 414 has enabled cache way 406 while disabling cache ways 408, 410, and 412. To avoid writing data into the disabled cache ways, active applications are assigned locations within cache way 406. An active application is an application that is currently being executed by a processor. With an application writing data to cache 404, replacement management table 402 identifies the application with an identifier located in identifier register 416. Replacement management table 402 is configured such that data can only be written into cache way 406 at this point in time. As a result, whenever a processor accesses a stream of data written by the application into cache 404, cache 404 is powered down such that only cache way 406 is powered or active.

Thus, using replacement management table 402, the operating system can restrict the number of ways used by applications by choosing a subset of ways for the RMT entries associated with the address of running high priority applications. The power management unit 414 can either be programmed by the operating system or programmed by the replacement management table to power on the active cache ways. The power management unit 414 can take two approaches to affecting power. First, in the general case, power management unit 414 does not power on the read/sense logic for inactive sets would not be powered on. Second, in the more specific case, the power management unit 414 can power off the SRAM in the cache associated with the inactive sets. The second case means the data in the inactive set is lost. In the first case, the data is still resident in the case, but can not be accessed.

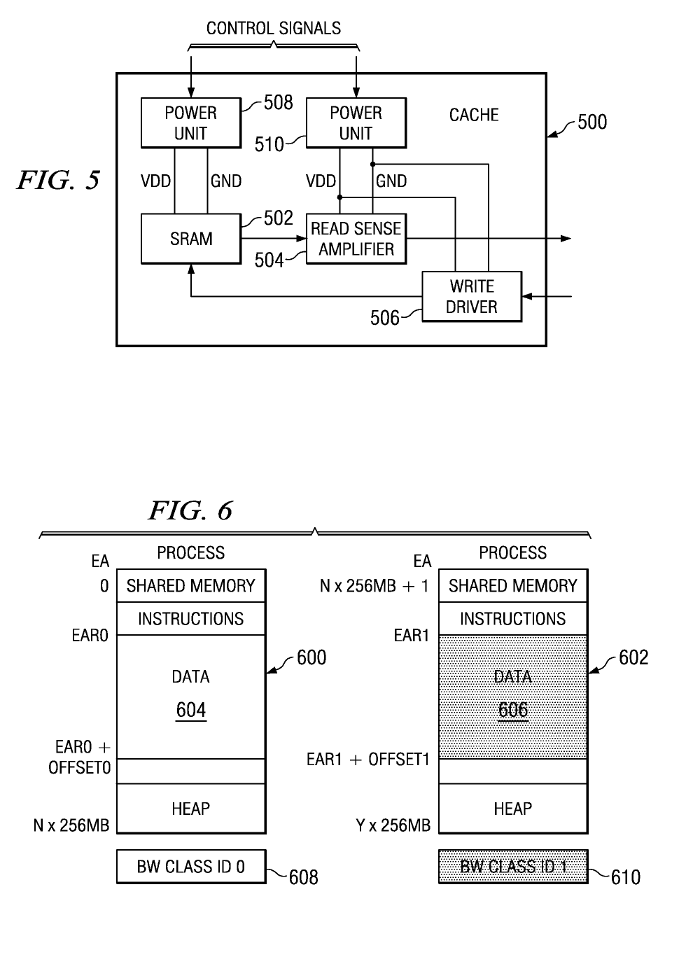

Turning now to FIG. 5, components in a cache that may be selectively enabled and disabled is depicted in accordance with an illustrative embodiment. In this example, cache 500 illustrates examples of components within cache 404 in FIG. 4. In this particular example, data is stored in static random access memory (SRAM) 502. Data is accessed in SRAM 502 through read sense amplifier 504 and write driver 506. These components are ones that are typically found within a cache, such as cache 500. Power is supplied to SRAM 502 through power unit 508, while power is supplied to read sense amplifier 504 and write driver 506 through power unit 510. Read sense amplifier 504 and write driver 506 are examples of read/write logic for cache 500. In these examples, power unit 508 and power unit 510 may be selectively enabled and disabled by control signals from a component, such as power management unit 414 in FIG. 4.

As illustrated, SRAM 502 represents a portion of a cache. In particular, SRAM 502 is the memory in which a particular way is located within cache 500. Only one SRAM and one set of read/write components are illustrated in cache 500 to depict the manner in which different portions of cache 500 may be enabled and disabled.

In this particular illustrative embodiment, the illustrative embodiments may enable or disable a way through controlling power to SRAM 502 through power unit 510. Alternatively, selectively powering read sense amplifier 504 and write driver 506 may be controlled by power unit 510. This enabling and disabling of power to these circuits provides an alternate way for enabling or disabling access to a particular way. In these examples, the access to data is for a read or write access.

Turning now to FIG. 6, a diagram illustrating effective address based on a replacement management table is depicted in accordance with an illustrative embodiment. In this example, process 600 is located at one memory range while process 602 is located in another effective address memory range. Process 600 contains data 604 while process 602 contains data 606. Data ranges for data 604 are mapped to identifier 608. In a similar fashion, data ranges for data 606 are mapped to identifier 610. These identifiers are in turn mapped to different ways within the cache. Essentially identifier register 416 contains the effective address range shown in FIG. 4 as mapped to identifier 608 and 610.

The embodiments write data for process 600 into a particular cache way based on identifier 608. In these examples, the data is written into an enabled or powered portion of a cache. In contrast, process 602 is for a process that is not currently active. In this example, a memory flow controller writes data 506 into a cache using identifier 610. In this example, process 602 is inactive and the cache way to be accessed by this process can be disabled. This situation means that a memory flow controller writes data 604 into a different cache way from data 606.

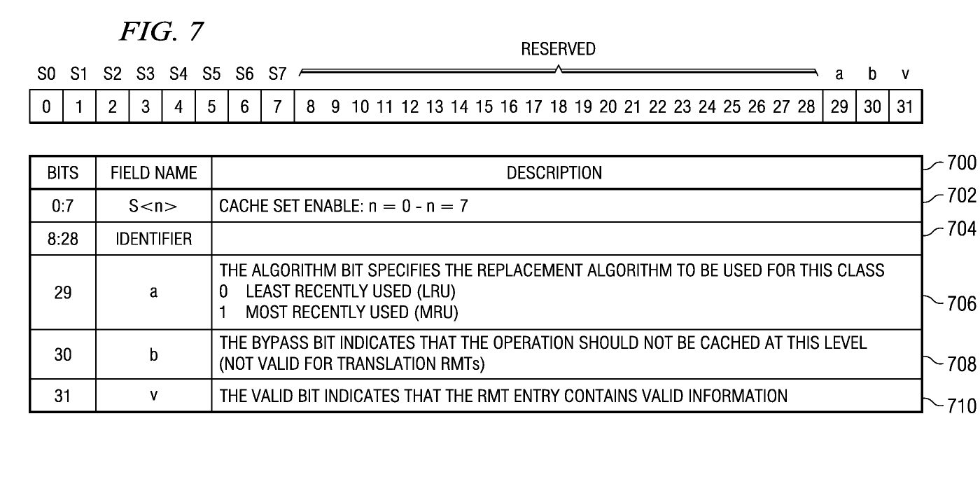

Turning now to FIG. 7, a diagram illustrating fields in an entry for a replacement management table is depicted in accordance with an illustrative embodiment. In this example, entry 700 is an example of an entry in a replacement management table, such as replacement management table 402 in FIG. 4. As illustrated, fields 702, 704, 706, 708, and 710 are present in entry 700. Field 702 identifies a cache set that is enabled. Field 706 specifies a replacement algorithm to be used for the particular class. Field 708 contains a bit that indicates a particular operation should not be cached at this particular level. Field 710 is a valid bit, indicating that the replacement management table entry contains valid information. In these examples, field 704 is implemented to contain the identifier for the particular application for the cache set.

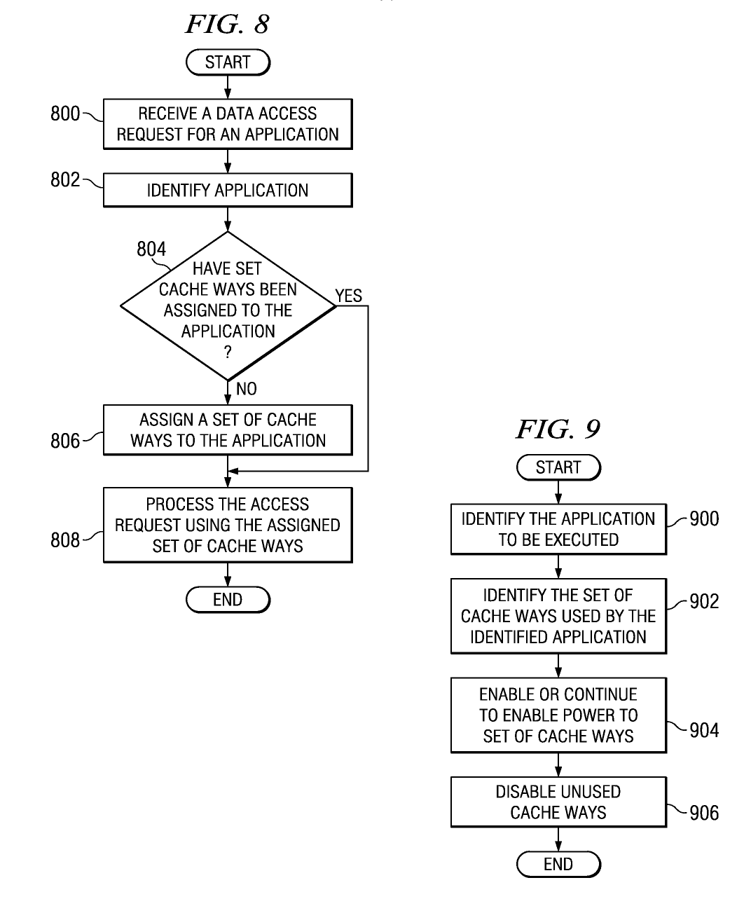

Turning now to FIG. 8, a flowchart of a process for writing data into a cache is depicted in accordance with an illustrative embodiment. In these examples, the process is implemented into a component, such as memory flow controller 300 in FIG. 3. Of course, the illustrated process may be implemented into any component used to write data into a cache or any other type of memory that has sections that may be selectively powered down to conserve the use of power.

The process begins by receiving a data access request for an application (step 800). In these examples, a memory flow controller, such as memory flow controller 300 in FIG. 3, receives the data access request. The process then identifies the application (step 802). The identifier for the application may be located in a register, such as identifier register 416 in FIG. 4. As mentioned above, this identifier may be written into the register by an operating system to identify the active application. A determination is made as to whether a set of cache ways have been assigned to the application (step 804). This determination is made by the memory flow controller consulting a replacement management table to see if the identification of the application has been assigned to a set of cache ways. A set of cache ways is a set of one or more cache ways for locations that may be powered on and off in the cache.

If a set of cache ways have not been assigned to the application, the process assigns a set of cache ways to the application (step 806). The process then processes the access request using the assigned set of cache ways (step 808) with the process terminating thereafter. The process proceeds directly to step 808 from step 804 if a set of cache ways have been assigned to the application.

Turning now to FIG. 9, a flowchart of a process for managing power to a cache is depicted in accordance with an illustrative embodiment. The process illustrated in FIG. 9 may be implemented in a control component, such as power management unit 414 in FIG. 4. This process is initiated each time a context switch occurs for an application. A context switch occurs when one application becomes active while another application becomes inactive.

The process begins by identifying the application to be executed (step 900). In these examples, the process identifies the application to be executed by accessing a register, such as identifier register 416 in FIG. 4. Thereafter, the process identifies the set of cache ways used by the identified application (step 902). This set of cache ways is a set of one or more cache ways assigned to the application. This identification of step 902 is made by accessing a replacement management table, such as replacement management table 314 in FIG. 3. The replacement management table contains the information identifying the set of cache ways used by a particular application. The process then enables or continues to enable power to the set of cache ways for the application (step 904). The process disables unused cache ways in the cache (step 906) with the process terminating thereafter.

Thus, the illustrative embodiments provide a computer implemented method, apparatus, and computer usable program code for managing power in a cache. In particular, the illustrative embodiments are applied to a cache that has different sections to which power may be separately enabled or disabled. The illustrative embodiments disable the portions of the cache that are unused by a process currently being executed by a processor. Other portions of the cache that are unused by the process are disabled. When a new process is switched in or becomes executed by the processor, the portions of the cache used by that new process are enabled while other portions are disabled. In this manner, the illustrative embodiments provide increased granularity in the manner in which power may be managed in a data processing system.

The illustrative embodiments can take the form of an entirely hardware embodiment, an entirely software embodiment or an embodiment containing both hardware and software elements. The illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments have been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer implemented method for managing power consumption in a cache, the computer implemented method comprising:
responsive to identifying a process requesting access to a cache, identifying a set of sections in the cache used by the process;
enabling power to each section in the set of sections in which power is disabled; and
disabling power to sections outside of the set of sections in which power is enabled.

2. The computer implemented method of claim 1 further comprising:
locating an identifier associated with the process.

3. The computer implemented method of claim 2, wherein the identifying step comprises:
responsive to locating the identifier for process requesting access to the cache, locating the set of sections using a data structure containing locations of data in the cache for different processes.

4. The computer implemented method of claim 3, wherein the data structure is a replacement management table.

5. The computer implemented method of claim 1, wherein the identifier is located in a register.

6. The computer implemented method of claim 5 further comprising:
writing the identifier in the register when a context switch in the process occurs.

7. The computer implemented method of claim 6, wherein the writing step is performed by an operating system.

8. The computer implemented method of claim 1, wherein the identifying, enabling, and disabling steps are performed by a memory flow controller.

9. The computer implemented method of claim 1, wherein the enabling and the disabling steps are performed by a power management unit.

10. The computer implemented method of claim 1, wherein the cache is accessed through a cache line lookup comprising generating an index to a congruence class and searching the congruence class across all ways.

11. The computer implemented method of claim 1, wherein power is enabled or disabled to a section in the set of sections by enabling or disabling power to the section.

12. The computer implemented method of claim 1, wherein power is enabled or disabled to a section in the set of sections by enabling or disabling read or write logic for section in the set of sections for which power is being enabled or disabled.

13. A computer program product for managing power consumption in a cache, the computer program product comprising a computer usable medium having computer usable program code tangible, embodied therein, the computer usable program code comprising:
computer usable program code, responsive to identifying a process requesting access to a cache, for identifying a set of sections in the cache used by the process;
computer usable program code for enabling power to each section in the set of sections in which power is disabled; and
computer usable program code for disabling power to sections outside of the set of sections in which power is enabled.

14. The computer program product of claim 13 further comprising:
computer usable program code for locating an identifier associated with the process.

15. The computer program product of claim 14, wherein the computer usable program code, responsive to identifying a process requesting access to a cache, for identifying a set of sections in the cache used by the process comprises:
computer usable program code, responsive to locating the identifier for process requesting access to the cache, for locating the set of sections using a data structure containing locations of data in the cache for different processes.

16. The computer program product of claim 15, wherein the data structure is a replacement management table.

17. The computer program product of claim 13, wherein the identifier is located in a register.

18. The computer program product of claim 17 further comprising:
computer usable program code for writing the identifier in the register when a context switch in the process occurs.

19. The computer program product of claim 13, wherein the computer usable program code, responsive to identifying a process requesting access to a cache, for identifying a set of sections in the cache used by the process, computer usable program code for enabling power to each section in the set of sections in which power it disabled, and the computer usable program code for disabling power to every section outside of the set of sections in which power is enabled are executed by a memory flow controller.

20. A data processing system comprising:
a bus;
a communications unit connected to the bus;
a memory connected to the bus, wherein the storage device includes a computer usable program code; and
a processor unit connected to the bus, wherein the processor unit executes the computer usable program code to identify a set of sections in the cache used by the process in response to identifying a process requesting access to a cache; enable power to each section in the set of sections in which power is disabled; and disable power to sections outside of the set of sections in which power is enabled.
